(19) United States
(12) Patent Application Publication
(10) Pub. No.: US 2021/0039718 A1
(43) Pub. Date: Feb. 11, 2021

(54) VEHICLE FRAME MEMBER AND VEHICLE

(71) Applicant: NIPPON STEEL CORPORATION, Tokyo (JP)

(72) Inventors: Atsuo KOGA, Tokyo (JP); Satoshi HIROSE, Tokyo (JP)

(73) Assignee: NIPPON STEEL CORPORATION, Tokyo (JP)

(21) Appl. No.: 16/966,428

(22) PCT Filed: Jan. 23, 2019
(86) PCT No.: PCT/JP2019/002123

§ 371 Date: Jul. 30, 2020

(30) Foreign Application Priority Data
Jan. 31, 2018 (JP) 2018-015259

(51) Int. Cl. B62D 21/15; B62D 25/20

(52) U.S. Cl. CPC B62D 21/15; B62D 25/20

(57) ABSTRACT

A vehicle framework component includes a hollow member and a reinforcing member. The hollow member includes therein mutually facing first surface and second surface. The reinforcing member, which includes a cylindrical tube having a quasi-circular cross section, stands on the first surface or the second surface inside the hollow member.

### TECHNICAL FIELD

The present disclosure relates to a vehicle framework component and a vehicle.

### BACKGROUND ART

Regulations on crash safety are intensifying year to year in the field of automobile industry. Accordingly, it is very important to achieve both of weight reduction (for improving fuel consumption) and crash safety.

Meanwhile, development of ecological automobiles (e.g. electric automobiles) has been advanced in view of global environmental protection. In electric automobiles, which include many batteries installed under the floor thereof, it is important to enhance the performance (primarily, energy absorption performance) of a side sill installed close to the batteries.

Vehicle framework components (e.g. bumpers, pillars and side sills) usually have hollow cross sections for weight reduction and, depending on the type of the components, internally installed reinforcing members to enhance the performance of the components.

The reinforcing member is installable, for instance, along a longitudinal direction of the vehicle framework component or in a direction orthogonal to the longitudinal direction of the vehicle framework component. A former arrangement, which partially increases the plate thickness, enhances the strength of the part where the reinforcing member is present. The reinforcing member in the latter arrangement, which serves as a partition in the vehicle framework component, increases torsion resistance and the strength of the part where the reinforcing member is present.

The deformation caused at the time of an automobile crash is broadly classified into three categories, i.e. bending deformation, axial collapse, and torsional deformation. The component subjected to the axial collapse and torsional deformation, which is likely to be entirely deformed, absorbs a large amount of energy per component weight.

In contrast, the component subjected to the bending deformation, which is deformed at a limited area, absorbs a small amount of energy per component weight. Especially, the smaller the size of an object (e.g. telephone pole) against which the component is hit (pole side collision, pole front collision) is, the smaller the deformation area and, consequently, the energy absorption become.

Typically, the reinforcing member is installed inside the vehicle framework component to ensure necessary energy absorption. However, the component can be hit at any part at the time of actual collision. Accordingly, the reinforcing member has to be installed to cover a certain extent of the area, disadvantageously increasing the component weight.

In view of the above, Patent Literature 1 discloses a structure for reinforcing a vehicle framework component (e.g. a door pillar and a side sill of a vehicle), in which a honeycomb structural body made of aluminum and reinforced plastic is inserted for reinforcement.

The reinforcement in the vehicle framework component by the honeycomb structural body of the invention disclosed in Patent Literature 1 leads to enhancement in the reinforcing effect and reduction in the increase of the component weight.

### CITATION LIST

### Patent Literature(S)

Patent Literature 1 JP 2014-177270 A

### SUMMARY OF THE INVENTION

### Problem(s) to be Solved by the Invention

However, according to the disclosure of Patent Literature 1, the vehicle framework component is typically provided by bending a thin steel sheet and the honeycomb structural body is made of the material different from steel (e.g. aluminum and reinforced plastic).

Accordingly, electrical corrosion between the different metals has to be prevented in bonding the vehicle framework component and the honeycomb structural body. Thus, the bonding process for the materials is limited (e.g. by an organic adhesive) in Patent Literature 1. Accordingly, it is difficult to efficiently reinforce the vehicle framework component at a desired point without increasing the component weight.

An object of the present disclosure is to provide a vehicle framework component and a vehicle capable of being efficiently reinforced at a desired point without increasing the component weight.

### Means for Solving the Problem(s)

A vehicle framework component according to an aspect of the disclosure includes: a hollow member; and at least one reinforcing member, in which the hollow member includes therein mutually facing first and second surfaces, the reinforcing member includes a cylindrical tube having a quasi-circular cross section, and the reinforcing member stands on the first surface or the second surface in the hollow member,

Herein, the quasi-circular cross section refers not only to a strictly truly circular cross section but also to an ellipsoidal cross section having a certain aspect ratio.

When an external force is applied to the vehicle framework component in a direction intersecting a longitudinal direction of the vehicle framework component, the hollow member of the vehicle framework component may be subjected to a bending deformation and/or the hollow member may be crushed by virtue of the external force. The term “crush” herein means that the cross section intersecting an axis of the hollow member is collapsed. The external force is applied to the hollow member in a direction intersecting the longitudinal direction (axial direction) of the hollow member and, to the reinforcing member, in a direction substantially along the axial direction of the reinforcing member.

At an initial stage of the deformation by the external force, the strength of the vehicle framework component against the pressing force can be enhanced by the reinforcing member supporting the hollow member.

In contrast, when the hollow member is crushed in the later stage of the deformation, the reinforcing member is also collapsed in the axial direction of the reinforcing member simultaneously with crushing of the hollow member. The crushing of the reinforcing member in the axial direction of the reinforcing member is referred to as “buckling.” The strength of the vehicle framework component against the external force can be enhanced by the resistance of the reinforcing member against buckling.

Especially, the reinforcing member, which is in a form of the cylindrical tube and has no ridge line, has a large resistance in an axial direction. Accordingly, even when a load is obliquely applied on the vehicle framework component, the reinforcing member stably buckles due to the constant deformation resistance irrespective of the parts of the reinforcing member. Accordingly, the strength against the external force can be enhanced irrespective of the direction of action of the force against the vehicle framework component.

Further, the reinforcing member, which is in a form of the cylindrical tube (i.e. not solid) and thus adds less weight even when being disposed within the hollow member, does not considerably increase the component weight.

In the above aspect of the disclosure, it is preferable that a first cover that blocks an end of the reinforcing member near the first surface is bonded to the reinforcing member.

The first cover bonded to the end of the reinforcing member near the first surface restricts the end of the reinforcing member. Accordingly, uneven deformation of the end of the reinforcing member near the first surface and consequent uneven energy absorption of the reinforcing member, which are caused by the partially applied crush load, can be prevented.

In the above aspect of the disclosure, it is preferable that a bonded portion between the first cover and the hollow member is provided.

The first cover, which is bonded to the reinforcing member, can be bonded to the hollow member, so that workability at the time of bonding can be enhanced.

Further, since the first cover is bonded, the number of the bonded points can be reduced as compared with an instance where the end of the reinforcing member is welded to the hollow member.

Furthermore, since the first cover is bonded, a large bonding area can be secured, so that other bonding process (e.g. the use of an adhesive) with lower bonding strength than welding is more readily employable.

In the above aspect of the disclosure, it is preferable that the bonded portion is a welded portion provided at a lateral portion between the first surface and the second surface of the hollow member.

The first surface of the hollow member is tensile-deformed when a load is applied from the side of the second surface of the hollow member. When the bonded portion is a welded portion, a heat affected zone is generated around the welded portion. The heat affected zone is sometimes damaged by the tensile deformation. Specifically, when there is a welded portion on the first surface of the hollow member, the heat affected zone is damaged upon a load applied from the side of the second surface of the hollow member, possibly causing significant reduction in the performance of the hollow member. Accordingly, the first cover is extended to the lateral portion, and the welded portion is provided on the lateral portion. Since the welded portion is not likely to be tensile-deformed, the welded portion is not easily destroyed.

In the above aspect of the disclosure, it is preferable that the welded portion is located near the second surface with respect to the first surface.

When the welded portion is located near the second surface of the hollow member with respect to the first surface, a compression deformation occurs at the side of the second surface of the hollow member, so that the welded portion is more unlikely to be destroyed.

In the above aspect of the disclosure, it is preferable that the end of the reinforcing member near the first surface is bonded to the hollow member through an adhesive.

The bonding strength of the adhesive is usually lower than the bonding strength of welding. Accordingly, the material and amount of the adhesive are preferably selected depending on the required bonding strength. For instance, the adhesive may be put into the hollow member and the end of the reinforcing member near the first surface may be buried in the adhesive put into the hollow member for bonding.

The end of the reinforcing member near the first surface and the hollow member may be bonded in various manners, and may be bonded through the adhesive. The adhesive can bond the hollow member and the reinforcing member even when the hollow member and the reinforcing member are made of different materials. Accordingly, the materials of the hollow member and the reinforcing member are more freely selectable.

In the above aspect of the disclosure, it is preferable that a second cover that blocks an end of the reinforcing member near the second surface is bonded to the reinforcing member.

When the vehicle framework component is used in a vehicle, the part of the hollow member near the second surface sometimes faces an outside of the vehicle and an outer surface of the vehicle is not necessarily flat. Further, an object to hit an outside of the vehicle does not necessarily have a flat surface that applies the external force (e.g. telephone poles and other vehicles). In other words, the external force is often unevenly applied on the part of the reinforcing member near the second surface. By closing the end of the reinforcing member near the second surface with the second cover, the external force is kept from being unevenly dispersed to be applied on the reinforcing member, thereby preventing deformation of the reinforcing member into an odd shape.

In the above aspect of the disclosure, it is preferable that the quasi-circular cross section of the reinforcing member has a ratio of a major axis to a minor axis of 2.5 or less.

As described above, the quasi-circular cross section refers not only to a truly circular cross section but also an ellipsoidal cross section. However, when the cross section is flattened so that the ratio of the major axis to the short axis exceeds 2.5, the reinforcing member may be bent at the time of deformation and/or easily collapsed depending on the direction of the external force. Accordingly, in order to crush the reinforcing member simultaneously with the crush of the hollow member, the cross section is preferably shaped so that the ratio of the major axis to the minor axis is 2.5 or less (i.e. capable of being categorized to be circular).

In the above aspect of the disclosure, it is preferable that the at least one reinforcing member includes a plurality of reinforcing members disposed in the hollow member, and a distance between axes of the cylindrical tubes of the respective reinforcing members is at most four times as large as a diameter of the reinforcing members.

When a plurality of reinforcing members are disposed in the hollow member, the strength against the external force is correspondingly enhanced. At this time, when the distance between respective reinforcing members is too large, the vehicle framework component is easily deformed depending on the position of the collision, so that sufficient strength against the external force cannot be secured. The reinforcing effect of the hollow member can be secured by arranging the reinforcing members at appropriate intervals (i.e. by setting the distance between respective axes of the plurality of reinforcing members at most four times as large as the diameter of the reinforcing members).

In the above aspect of the disclosure, it is preferable that the reinforcing member is made of a steel material.

The components of the vehicle are usually made of steel materials. With the reinforcing member made of a steel material, bondability by welding or the like can be enhanced. In addition, the use of the steel material, which is easily processable and inexpensive, can achieve reduction in the production cost and component cost of the vehicle framework component.

In the above aspect of the disclosure, it is preferable that the hollow member is made of a steel material.

The components of the vehicle are usually made of steel materials. With the hollow member made of a steel material, bondability with the other component can be enhanced. In addition, the use of the steel material, which is easily processable and inexpensive, can achieve reduction in the production cost and component cost of the vehicle framework component.

A vehicle according to another aspect of the disclosure includes the above-described vehicle framework component, the vehicle framework component being installed so that the first surface of the hollow member is situated near an inside of the vehicle and the second surface is situated near an outside of the vehicle.

The vehicle using the above-described vehicle framework component can exhibit enhanced strength against external force.

Further, by placing the hollow member so that the first surface is situated near the inside of the vehicle and the second surface is situated near the outside of the vehicle, the vehicle can resist the external force from the outside of the vehicle.

### BRIEF DESCRIPTION OF DRAWING(S)

FIG. 1 is a cross-sectional view showing a vehicle framework component according to a first exemplary embodiment of the disclosure.

FIG. 2 is an exploded perspective view showing the vehicle framework component according to the first exemplary embodiment.

FIG. 3 is a cross-sectional view showing a vehicle framework component according to a second exemplary embodiment of the disclosure.

FIG. 4 is an exploded perspective view showing the vehicle framework component according to the second exemplary embodiment.

FIG. 5 is a cross-sectional view showing a vehicle framework component according to a third exemplary embodiment of the disclosure.

FIG. 6 is a cross-sectional view showing a vehicle framework component according to a fourth exemplary embodiment of the disclosure.

FIG. 7A is a cross-sectional view showing a vehicle framework component according to a fifth exemplary embodiment of the disclosure.

FIG. 7B is a cross-sectional view showing a vehicle framework component according to a modification of the fifth exemplary embodiment.

FIG. 7C is a cross-sectional view showing a vehicle framework component according to another modification of the fifth exemplary embodiment.

FIG. 8 is a cross-sectional view showing a vehicle framework component according to a sixth exemplary embodiment of the disclosure.

FIG. 9 is an illustration schematically showing a test method for evaluating a bending resistance in Example.

FIG. 10 is a graph showing results of the bending resistance in Example and Comparative.

FIG. 11 is an illustration schematically showing a test method for evaluating crush resistance in Examples.

FIG. 12 is a graph showing the results of the crush resistance in Example and Comparative.

FIG. 13 is a graph showing the results of the crush resistance against a vertical load in Examples.

FIG. 14 is an illustration schematically showing a modified test method for evaluating the crush resistance in Examples.

FIG. 15 is a graph showing the results of the crush resistance with crush loads in different directions of action in Examples.

FIG. 16 is another graph showing the results of the crush resistance with the crush loads in different directions of action in Examples.

### DESCRIPTION OF EMBODIMENT(S)

Exemplary embodiments of the disclosure will be described below.

### 1. First Exemplary Embodiment

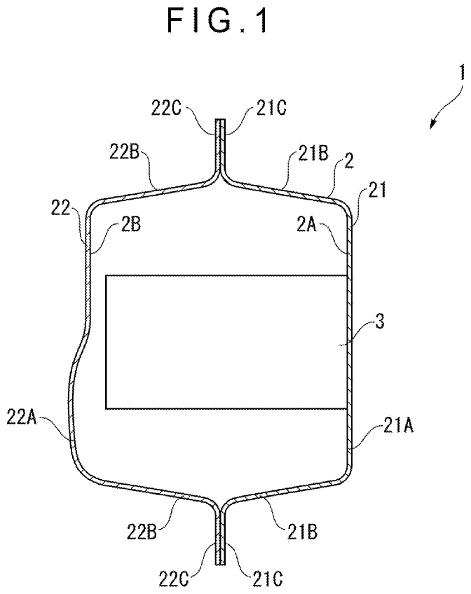

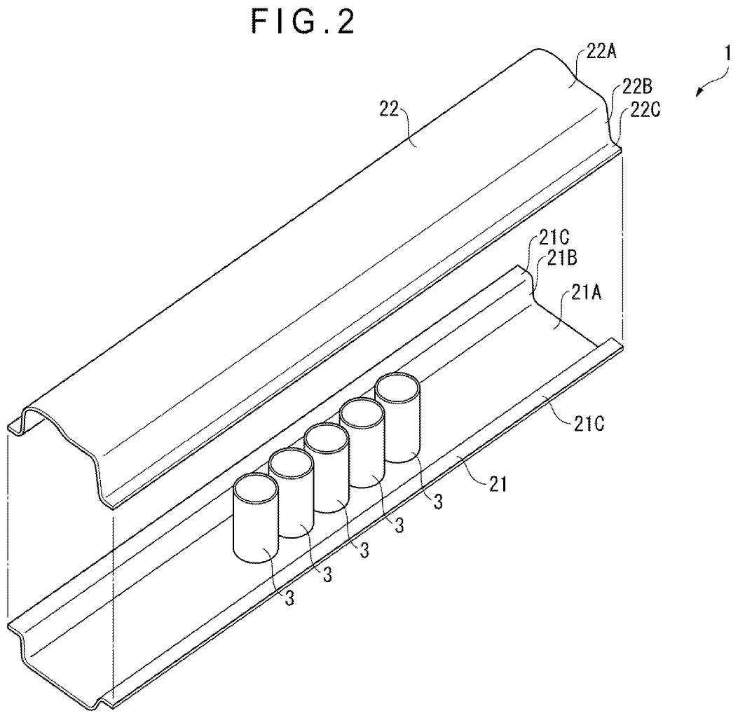

FIGS. 1 and 2 show a vehicle framework component 1 according to a first exemplary embodiment of the disclosure. FIG. 1 is a cross-sectional view in a direction orthogonal to an extension direction of the vehicle framework component 1. FIG. 2 is an exploded perspective view of the vehicle framework component 1.

The vehicle framework component 1 is a component used for a vehicle (e.g. automobiles) to form a vehicle framework such as a side sill and a door pillar. The vehicle framework component 1 can also be provided at a front side of a vehicle body to be used as a bumper for absorbing energy at a frontal crash. The vehicle framework component 1 includes a hollow member 2 and a reinforcing member 3.

The hollow member 2 is a steel tubular component defining mutually facing first surface 2A and second surface 2B therein. The hollow member 2 is provided by combining an inner member 21 and an outer member 22. It should be noted that the hollow member 2 is not necessarily made of a steel material but may be made of other material such as aluminum, FRP (Fiber-Reinforced Plastic) or the like.

The inner member 21 is a steel component of a hat-shaped cross section, which is made of, for instance, a 1.6-mm thick high-tensile steel sheet having 1180 MPa class tensile strength. The inner member 21 includes a bottom portion 21A, lateral portions 21B, and flanges 21C.

The bottom portion 21A, which is a bottom of the hat shape, defines an inner side of the hollow member when the hollow member is attached to a vehicle body. An inner surface of the bottom portion 21A is the first surface 2A of the hollow member 2.

The lateral portions 21B, which rise from respective ends (in an width direction) of the bottom portion 21A, are oppositely disposed to define an upper side and a lower side of the hollow member 2 when the hollow member 2 is attached to the vehicle body.

The flanges 21C are formed by outwardly bending respective ends of the lateral portions 21B.

The outer member 22, which is also a steel component of a hat-shaped cross section like the inner member 21, includes a bottom portion 22A, two lateral portions 22B, and flanges 22C. The outer member 22 defines an outer side of the hollow member 2 when the hollow member 2 is attached to the vehicle body. In the first exemplary embodiment, the bottom portion 22A is partially bulged outward to conform to the shape of the vehicle body. An inner surface of the bottom portion 22A is the second surface 2B of the hollow member 2.

The flanges 21C of the inner member 21 and the flanges 22C of the outer member 22 are mutually overlapped when the hollow member 2 is assembled. The overlapped flanges 21C, 22C are bonded through arc welding or the like to be integrated, thereby forming the hollow member 2.

The reinforcing member 3 is provided by a plurality of tubular steel tubes (sometimes referred to as reinforcing members 3 hereinafter) installed inside the hollow member 2. The reinforcing member 3 stands on the first surface 2A of the hollow member 2. It should be noted that the term “stands” herein means that the reinforcing member 3 is disposed so that an axis of the reinforcing member 3 in a form of the tubular component intersects the first surface 2A. An angle defined by the axis of the reinforcing member 3 and the first surface 2A is approximately 90 degrees. The steel tubes for the reinforcing member 3 are made of, for instance, a 1.6-mm thick high-tensile steel having 590 MPa class tensile strength.

The reinforcing member 3, which can be produced by cutting a tube material into a predetermined length, is not necessarily made of a seamless tube but may be made of a welded tube.

Further, the reinforcing member 3 is not necessarily made of a steel material but may be made of other materials such as aluminum, FRP (Fiber-Reinforced Plastic) and the like. However, in terms of the component cost and the production process (e.g. bonding method), the reinforcing member 3 is preferably made of the same type of material as that of the hollow member 2.

The reinforcing member 3 is disposed at the center of the first surface 2A of the hollow member 2. As shown in FIG. 2, a plurality of (five in the first exemplary embodiment) reinforcing members 3 are arranged in an extension direction of the hollow member 2. The end of each of the reinforcing members 3 facing the first surface 2A is bonded to the first surface 2A of the hollow member 2 by arc welding or the like.

Distances between cylindrical axes of the plurality of reinforcing members 3 are preferably defined so that a slight gap is formed between adjacent ones of the reinforcing members 3, and are preferably set at most four times as large as the diameters of the reinforcing members 3. When the distances between the cylindrical axes of the plurality of reinforcing members 3 are less than twice the diameter of the cylinder, the adjacent ones of the reinforcing members 3 are mutually interfered to make it difficult to be installed and, consequently, be produced. With the reinforcing members 3 being spaced as described above, the hollow member 2 can securely exhibit the reinforcing effect.

Each of the reinforcing members 3 is not necessarily a cylindrical tube having a strictly circular cross section. For instance, the reinforcing member 3 in a form of the cylindrical tube may have a quasi-circular cross section, which include an ellipsoid whose ratio of major axis to minor axis is 2.5 or less. In sum, the reinforcing member 3 may be flattened in any manner as long as buckling deformation stably occurs when an external force is applied in an axial direction of the reinforcing member 3.

When the vehicle framework component 1 is produced, as shown in FIG. 2, the inner member 21 is placed with the flanges 21C facing upward and the reinforcing member 3 is placed on the bottom portion 21A of the inner member 21. Next, the bottom portion 21A and the end of the reinforcing member 3 facing the first surface 2A are welded by arc welding or the like. Finally, with the flanges 22C of the outer member 22 facing downward, the flanges 21C of the inner member 21 and the flanges 22C of the outer member 22 are overlapped and welded through spot welding or the like for bonding.

As described above, the vehicle framework component 1 is usable for a side sill, a door pillar, or a bumper forming a framework of a vehicle body. Further, the usable automobile includes not only a typical gasoline-fueled automobile but also ecological automobiles (e.g. electric automobiles).

Especially, electric automobiles house electricity-storing batteries under the floor of the vehicle body. The batteries may be damaged if an external force is applied to the vehicle body and the batteries are affected by the external force. Accordingly, the vehicle framework component 1 is preferably used as a side sill provided at a lower lateral side of the vehicle body.

### 2. Second Exemplary Embodiment

Next, a second exemplary embodiment of the disclosure will be described below. Note that the same components and the like as those having been described above are provided with the same numerals, and detailed descriptions of the components and the like are omitted.

In the above-described first exemplary embodiment, the end of the reinforcing member 3 facing the first surface 2A is directly bonded to the bottom portion 21A of the inner member 21 defining the first surface 2A of the hollow member 2.

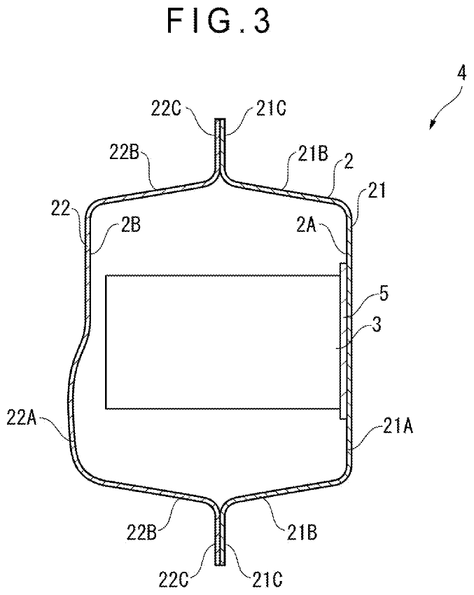

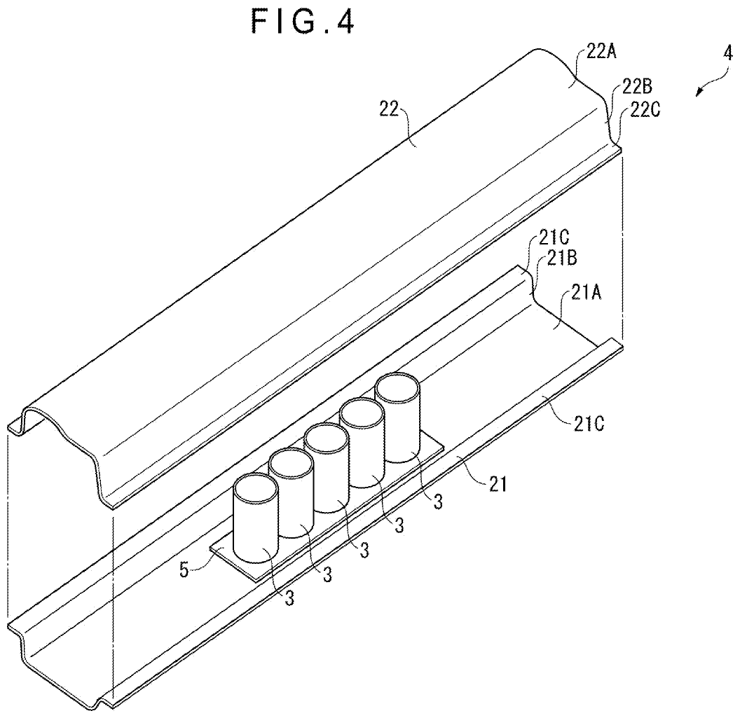

In contrast, a vehicle framework component 4 according to the second exemplary embodiment includes a first cover 5 that blocks ends of the plurality of reinforcing members 3 facing the first surface 2A, as shown in FIGS. 3 and 4.

The first cover 5 is provided by a rectangular steel sheet. The steel sheet is, for instance, a 1.6-mm thick high-tensile steel having 590 MPa class tensile strength.

The end of each of the reinforcing members 3 facing the first surface 2A is bonded to a facing surface of the first cover 5 by welding or the like. Further, a surface of the first cover 5 opposite the facing surface bonded to the reinforcing member 3 is bonded to the first surface 2A of the hollow member 2 by welding or the like.

When the vehicle framework component 4 is produced, the first cover 5 is initially placed on a table and the reinforcing member 3 is bonded to the first cover 5 by arc welding or the like. Next, the first cover 5 with the reinforcing member 3 is placed on the bottom portion 21A of the inner member 21. Finally, the first cover 5 and the bottom portion 21A are bonded by arc welding or the like. The subsequent assembly process for the vehicle framework component 4 is the same as that in the first exemplary embodiment.

The plurality of reinforcing members 3 of the vehicle framework component 4 are integrated by the first cover 5 to bind the ends of the reinforcing members 3. Uneven deformation and consequent uneven energy absorption, which are caused by the external force partially applied on the reinforcing members 3, can thus be prevented.

The first cover 5 of the vehicle framework component 4 is welded to the bottom portion 21A of the inner member 21. The welding, which can thus be achieved between steel plates, results in enhancement in weldability and widened weld area. Further, since the reinforcing members 3 are integrated by the first cover 5, the number of the welded points can be reduced as compared with an instance where the ends of the reinforcing members 3 are each welded to the bottom portion 21A.

### 3. Third Exemplary Embodiment

Next, a third exemplary embodiment of the disclosure will be described below.

In the vehicle framework component 1 according to the above-described first exemplary embodiment, the reinforcing member 3 is welded to the bottom portion 21A of the inner member 21 of the hollow member 2.

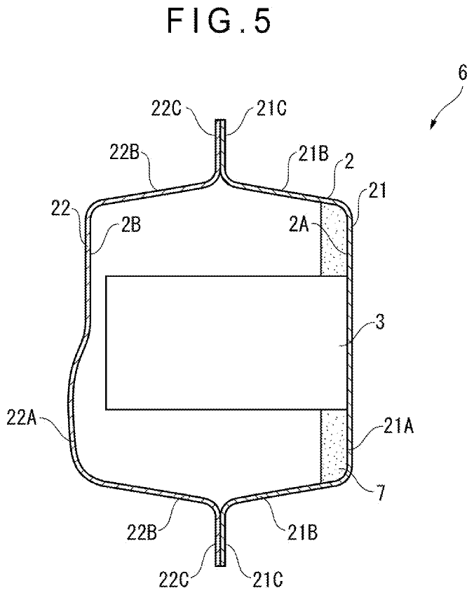

In contrast, the reinforcing member 3 of a vehicle framework component 6 according to the third exemplary embodiment is different from the first exemplary embodiment in that the reinforcing member 3 is bonded to the bottom portion 21A of the inner member 21 of the hollow member 2 by an adhesive 7, as shown in FIG. 5. The adhesive 7 may be any adhesive such as thermosetting synthetic resin adhesive and photo-curable synthetic resin adhesive. It should be noted that the adhesive 7 is preferably added with a flame retardant or the like to provide fire resistance.

When the vehicle framework component 6 is produced, the bottom portion 21A of the inner member 21 of the hollow member 2 is placed on a table or the like. Then, after the reinforcing member 3 is placed on the bottom portion 21A, the adhesive 7 is poured into a dent of the hat-shape of the inner member 21. Lastly, the adhesive 7 is cured by, for instance, applying heat on the adhesive 7 or illuminating the adhesive 7 with light. The subsequent assembly process for the vehicle framework component 6 is the same as that in the first exemplary embodiment.

The adhesive 7 can bond the hollow member 2 and the reinforcing member 3 even when the hollow member 2 and the reinforcing member 3 are made of different materials. Accordingly, the materials of the hollow member 2 and the reinforcing member 3 are more freely selectable to provide the vehicle framework component 6 with desired performance.

Further, the reinforcing member 3, which can be bonded to the hollow member 2 only by pouring the adhesive 7 in the dent of the hat-shape of the inner member 21 of the hollow member 2, is easily installable.

### 4. Fourth Exemplary Embodiment

Next, a fourth exemplary embodiment of the disclosure will be described below.

The vehicle framework component 4 according to the above-described second exemplary embodiment includes the first cover 5 that blocks ends of the plurality of reinforcing members 3 facing the first surface 2A.

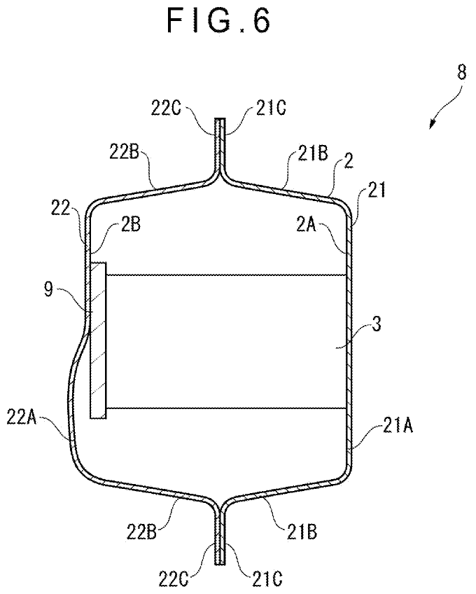

In contrast, a vehicle framework component 8 according to the fourth exemplary embodiment includes a second cover 9 that blocks ends of the reinforcing members 3 facing the second surface 2B, as shown in FIG. 6.

The second cover 9, which is made of a rectangular steel sheet, spans over the plurality of reinforcing members 3. The plurality of reinforcing members 3 are welded to the second cover 9 as in the second exemplary embodiment.

The second cover 9 is bonded to the bottom portion 22A of the outer member 22 of the hollow member 2 by welding or the like. However, a part of the bottom portion 22A of the outer member 22, which is bulged outward, is not welded. It should be noted that, when the outwardly bulging portion is enlarged depending on the design of the vehicle body, the second cover 9 may be unwelded to the bottom portion 22A. Further, the first cover 5 may be provided at ends of the reinforcing members 3 near the first surface 2A as in the second exemplary embodiment in addition to the second cover 9 of the fourth exemplary embodiment.

It is preferable that the second cover 9 spans over the plurality of reinforcing members 3. With this arrangement, even when a thin object (e.g. a telephone pole) hits against the location of the reinforcing members 3, the external force is transferred to the plurality of reinforcing members 3 through the second cover 9, thereby crushing the plurality of reinforcing members 3.

### 5. Fifth Exemplary Embodiment

Next, a fifth exemplary embodiment of the disclosure will be described below. In the above-described second exemplary embodiment, the first cover 5 is made of a rectangular steel sheet.

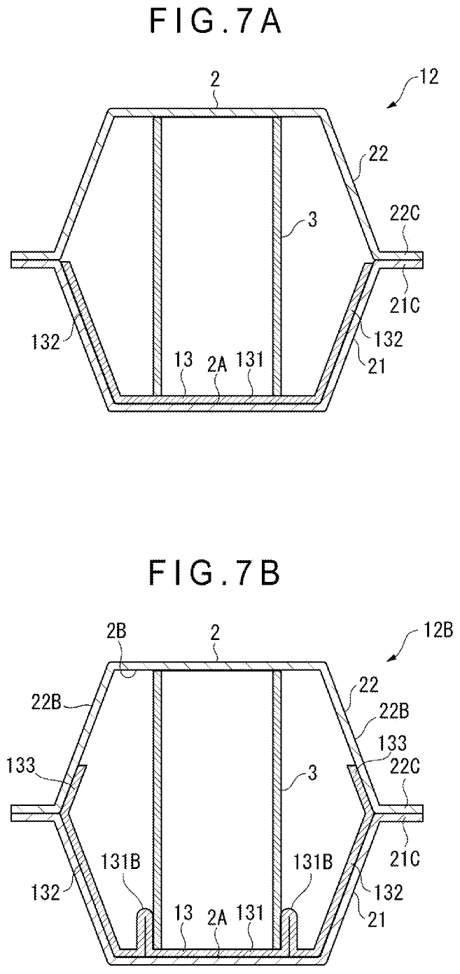

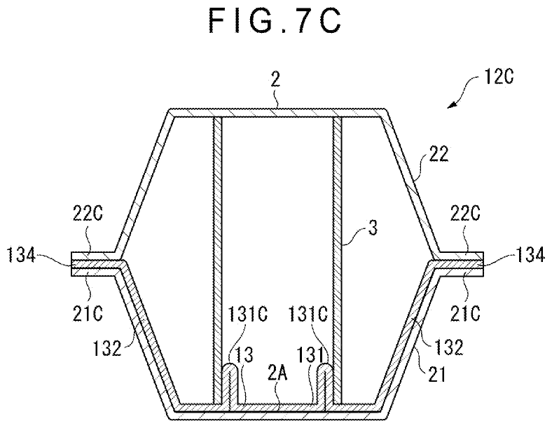

In contrast, a first cover 13 of a vehicle framework component 12 according to the fifth exemplary embodiment is of a different shape as shown in FIG. 7A.

The first cover 13 is interposed between the reinforcing member 3 and the first surface 2A of the hollow member 2. The first cover 13, which has a trapezoidal cross section, is formed by bending a steel sheet. The first cover 13 includes a bottom portion 131 and slant surfaces 132.

A first side of the bottom portion 131 is in contact with the end of the reinforcing member 3 near the first surface 2A. A second side of the bottom portion 131 is in contact and welded with the first surface 2A. The slant surfaces 132 rise from respective ends of the bottom portion 131 by a predetermined angle. The slant angle of the slant surfaces 132 is determined so that the slant surfaces 132 conform to the inner shape of the inner member 21 of the hollow member 2.

Ends of the respective slant surfaces 132 reach the points of the inner member 21 of the hollow member 2 at which the inner member 21 is bent to form the flanges 21C.

The same effects and advantages as those in the above-described exemplary embodiments can be achieved by the fifth exemplary embodiment.

The first cover 13, which is made of the trapezoidal steel sheet, does not move inside the hollow member 2. Thus, a relative movement of the reinforcing member 3 and the hollow member 2 can be prevented, thereby further enhancing the reinforcing effect by the reinforcing member 3.

The fifth exemplary embodiment may be further modified. For instance, extensions 133 may be provided at the respective ends of the slant portions 132 of the first cover 13 of a vehicle framework component 12B as shown in FIG. 7B. The extensions 133 extend to a point nearer to the second surface 2B than the first surface 2A of the hollow member 2. The extensions 133, which are bonded portions to the lateral portions 22B of the outer member 22 of the hollow member 2, are bonded by welding or the like.

Bent protrusions 131B are formed on the bottom portion 131 of the first cover 13. The bent protrusions 131B are in contact with outer sides of the reinforcing member 3. The bent protrusions 131B restrict a movement of the reinforcing member 3 in a direction along the first surface 2A, thus further enhancing the reinforcing effect.

When an external force is applied to the hollow member 2 of the vehicle framework component 12B, the bonded portions between the extensions 133 and the lateral portions 22B are subjected to a compression deformation. When the extensions 133 and the lateral portions 22B are welded, the heat affected zone, which is generated by welding, is not easily destroyed, thereby enhancing the bonding strength of the bonded portion.

As shown in FIG. 7C, ends of the first cover 13 of the vehicle framework component 12C may be bent to form flanges 134, each of which may be held between the flange 21C and the flange 22C of the hollow member 2.

Bent protrusions 131C are formed on the bottom portion 131 of the first cover 13. The bent protrusions 131C are in contact with inner sides of the reinforcing member 3. The movement of the reinforcing member 3 in the direction along the first surface 2A is also restricted by this arrangement, thus further enhancing the reinforcing effect.

The vehicle framework component 12C, which completely restricts the movement of the first cover 13, further enhances the reinforcing effect by the reinforcing member 3.

### 6. Sixth Exemplary Embodiment

Next, a sixth exemplary embodiment of the disclosure will be described below.

The end of the reinforcing member 3 near the outer member 22 is in a single virtual plane in the above-described first exemplary embodiment.

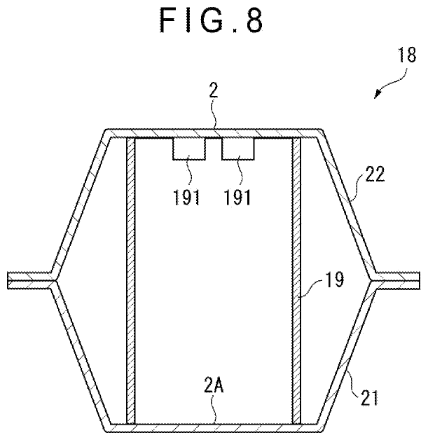

In contrast, a reinforcing member 19 of a vehicle framework component 18 according to the sixth exemplary embodiment is different from the reinforcing member 3 in that the reinforcing member 19 includes a plurality of cut portions 191 at an end of the reinforcing member 19 near the outer member 22, as shown in FIG. 8.

The plurality of cut portions 191 are arranged along the width direction of the reinforcing member 19. The profile of each of the cut portions 191 is, for instance, rectangular. The cut portions 191 can be formed by cutting the first and second members of the reinforcing member 19 using a blade with square teeth. It should be noted that the cut portions 191 are not necessarily configured as described above but may have a triangular profile(s).

The same effects and advantages as those in the above-described exemplary embodiments can be achieved by the sixth exemplary embodiment.

Further, when an external force is applied, the part provided with the cut portions 191 firstly collapses due to the presence of the plurality of cut portions 191, so that the reinforcing member 19 is easily crushed in the axial direction. A part of the reinforcing member 19 adjacent to the buckled part in the axial direction is also deformed, whereby the part of the reinforcing member 19 is more easily buckled than an undeformed part of the reinforcing member 19. In other words, after the part provided with the cut portion 191 is initially buckled, the buckling can sequentially occur in the axial direction.

### EXAMPLES

The reinforcing effects of the vehicle framework component 1 of the first exemplary embodiment and the vehicle framework component 4 of the second exemplary embodiment were checked. Bending resistance and crush resistance were evaluated as the resistance against an external force.

1. Evaluation of Bending Resistance

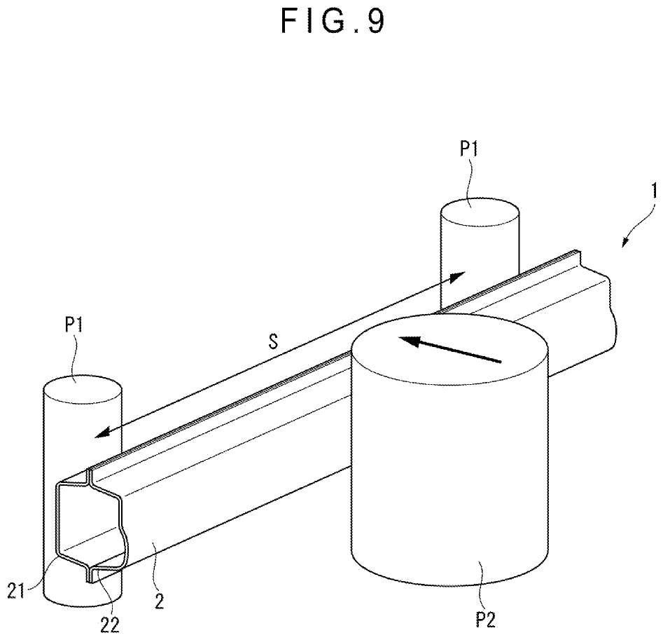

As shown in FIG. 9, while the vehicle framework component 1 (Example 1) was supported by two poles P1, a pole P2 was hit at the center of the vehicle framework component 1 to apply an external force, thereby evaluating the bending resistance of the vehicle framework component 1. Five reinforcing members 3 each in a form of circular tube of 50-mm diameter and 1.6-mm thickness were provided inside the hollow member 2 of the vehicle framework component 1. The reinforcing member 3 weighed 200 g per piece.

A support span S between the poles P1 was set at 1000 mm. The pole P2 was 250 mm in diameter with a telephone pole in mind. The external force was applied from the side of the outer member 22 of the hollow member 2, which was to be located outside a vehicle body.

As a Comparative, the bending resistance was evaluated for a vehicle framework component not provided with the reinforcing member 3 inside the hollow member 2.

The characteristic value for the evaluation was a value calculated by dividing the load applied by the pole P2 by a mass of the vehicle framework component (external force/mass of the component: kN/kg).

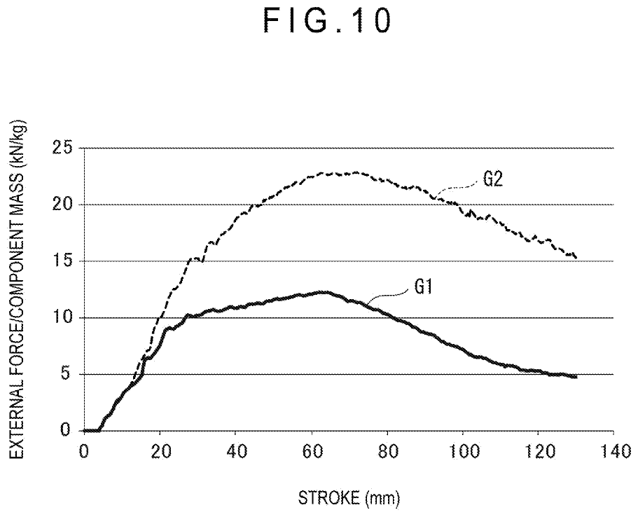

The results of the evaluation of the bending resistance for Example 1 and Comparative are shown in FIG. 10. It should be noted that the horizontal axis of FIG. 10 is a stroke of the pole P2 (i.e. a displacement of the pole P2 after contacting the side sill member).

In the Comparative, the bending resistance was 15 kN/kg at the maximum as shown in a graph G1 in FIG. 10.

In contrast, the maximum value in Example 1 was 20 kN/kg or more as shown in a graph G2 in FIG. 10. Accordingly, it is confirmed that the reinforcing member 3 installed inside the hollow member 2 can significantly enhance the bending resistance without considerable increase in the component weight.

2. Evaluation of Crush Resistance

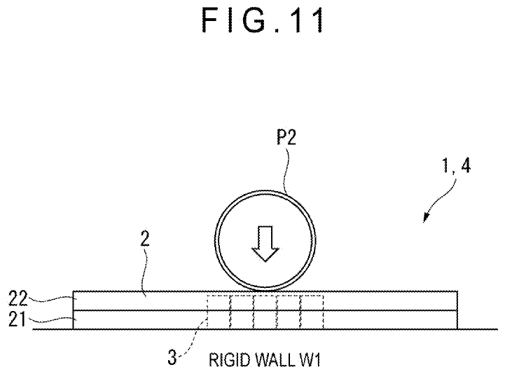

As shown in FIG. 11, while the vehicle framework component 1(4) was supported by a rigid wall W1, an external force was applied to the center of the vehicle framework component 1(4) by the pole P2 to evaluate the crush resistance of the vehicle framework component 1(4). The rigid wall was placed vertically with respect to an application direction of the external force.

The crush load of the 250-mm-diameter pole P2 was applied to a part (center) of the vehicle framework component 1(4) where the reinforcing member 3 was placed.

As a Comparative, the crush resistance was evaluated for a vehicle framework component not provided with the reinforcing member 3 inside the hollow member 2, as in evaluating the bending resistance.

The characteristic value for the evaluation was also the value calculated by dividing the external force applied by the pole P2 by the mass of the vehicle framework component 1(4) (external force/mass of the component: kN/kg), as in evaluating the bending resistance.

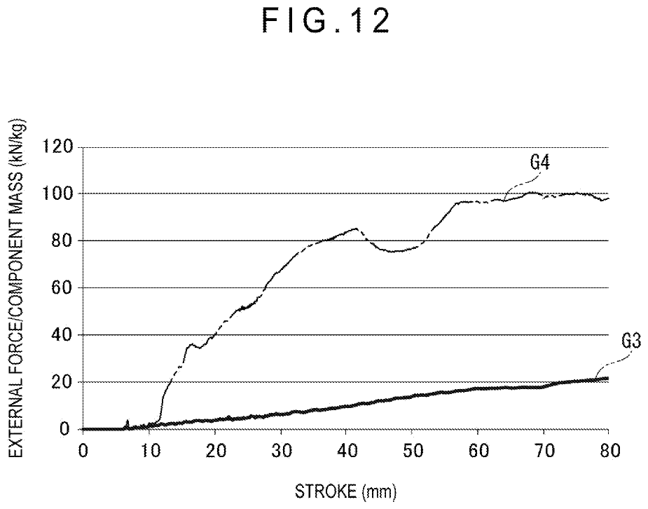

The results of comparison of the performance against the crush load between the vehicle framework component 1 and the vehicle framework component not provided with the reinforcing member 3 therein are shown in FIG. 12.

In the Comparative, the crush resistance was approximately 20 kN/kg at the maximum as shown in a graph G3 in FIG. 12.

In contrast, the crush resistance of Example 1 was 100 kN/kg at the maximum as shown in a graph G4 in FIG. 12. Accordingly, it is confirmed that the reinforcing member 3 installed inside the hollow member 2 can significantly enhance the crush resistance without considerable increase in the component weight.

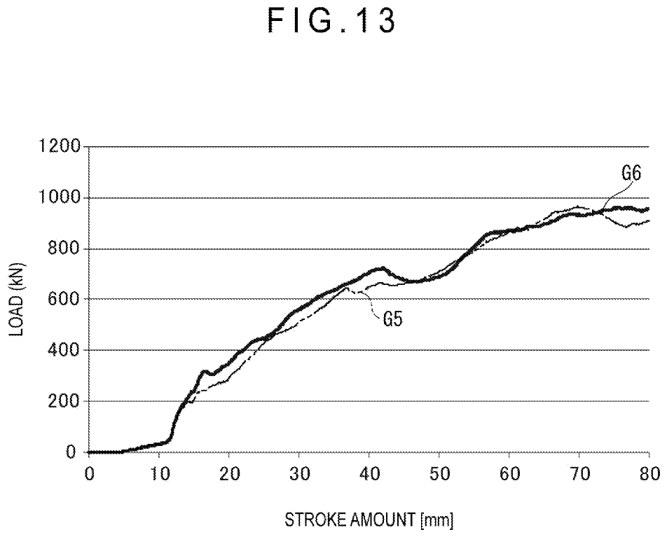

The results of comparison of the crush resistances between the vehicle framework component 1 (Example 2) and the vehicle framework component 4 (Example 3) provided with the first cover 5 as evaluated through the method shown in FIG. 11 are shown in FIG. 13.

The results of Example 2 are shown in a graph G5 in FIG. 13. In contrast, the results of Example 3 are shown in a graph G6 in FIG. 13.

It is confirmed that Examples 2 and 3 both show excellent results. Accordingly, it is confirmed that the vehicle framework components 1, 4 have approximately the same crush resistance against a load applied in the vertical direction.

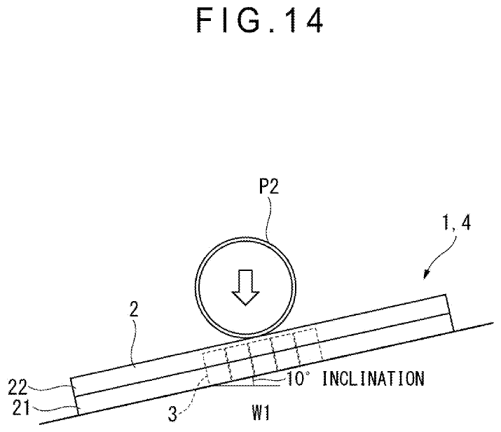

As shown in FIG. 14, the rigid wall W1 for supporting the vehicle framework component 1(4) was slanted by 10 degrees from the state shown in FIG. 11 for evaluation of the crush resistance of the vehicle framework component 1(4) when the crush load was obliquely applied to the vehicle framework component 1.

The load bearing capacity in an oblique direction, which is supposed to be an index for the performance of a vehicle when obliquely hitting a telephone pole or the like, is one of items measured in a side crash test performed in NHTSA.

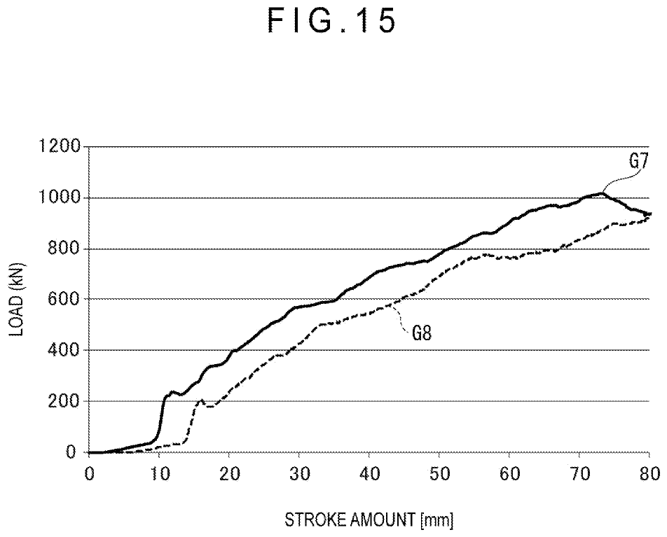

The results of the crush resistance of the vehicle framework component 1 when the crush load was applied in a vertical direction as shown in FIG. 11 (Example 4) and when the crush load was obliquely applied (Example 5) are shown in FIG. 15.

The results in Example 4, which are shown in a graph G7 in FIG. 15, show sufficient crush resistance. However, the results in Example 5, which are shown in a graph G8 in FIG. 15, show that the crush resistance is, though at a sufficient level, inferior to that in Example 4.

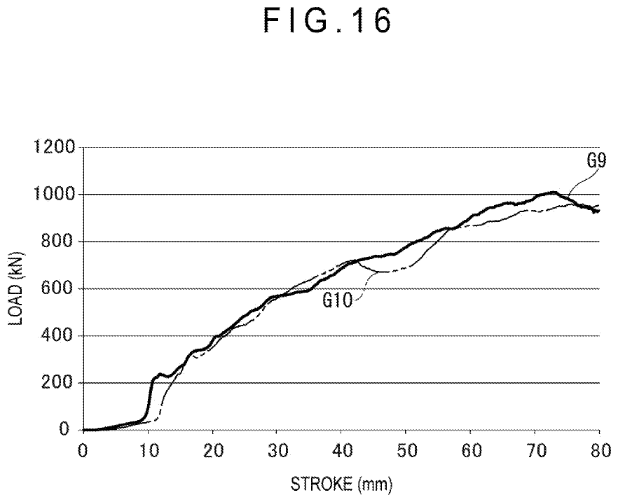

In contrast, the results of the vehicle framework component 4 employing the first cover 5 are shown in FIG. 16. The results when the crush load was applied in a vertical direction (Example 6) is shown by a graph G9 in FIG. 16. The results when the crush load was obliquely applied (Example 7) are shown by a graph G10 in FIG. 16. It is confirmed that the vehicle framework component 4 shows approximately the same crush resistance in both instances.

The results show that the crush resistance of the vehicle framework component 4 does not greatly change even when the crush load is applied in a direction other than the axial direction of the cylindrical tube of the reinforcing member 3, which means that the vehicle framework component 4 is highly robust.

### EXPLANATION OF CODE(S)

1 . . . vehicle framework component, 2 . . . hollow member, 2A . . . first surface, 2B . . . second surface, 3 . . . reinforcing member, 4 . . . vehicle framework component, 5 . . . first cover, 6 . . . vehicle framework component, 7 . . . adhesive, 8 . . . vehicle framework component, 9 . . . second cover, 12 . . . vehicle framework component, 12B . . . vehicle framework component, 12C . . . vehicle framework component, 13 . . . first cover, 18 . . . vehicle framework component, 19 . . . reinforcing member, 21 . . . inner member, 21A . . . bottom portion, 21B . . . lateral portion, 21C . . . flange, 22 . . . outer member, 22A . . . bottom portion, 22B . . . lateral portion, 22C . . . flange, 131 . . . bottom portion, 131B . . . bent protrusion, 131C . . . bent protrusion, 132 . . . slant portion, 133 . . . extension, 134 . . . flange, 191 . . . cut portion, P1 . . . pole, P2 . . . pole, S . . . support span, W1 . . . rigid wall

1. A vehicle framework component comprising:
a hollow member; and
at least one reinforcing member, wherein
the hollow member comprises therein mutually facing first and second surfaces,
the reinforcing member comprises a cylindrical tube having a quasi-circular cross section,
the reinforcing member stands on the first surface or the second surface in the hollow member, and
the reinforcing member is made of a steel material.

2. The vehicle framework component according to claim 1, wherein
a first cover that blocks an end of the reinforcing member near the first surface is bonded to the reinforcing member.

3. The vehicle framework component according to claim 2, further comprising:
a bonded portion between the first cover and the hollow member.

4. The vehicle framework component according to claim 3, wherein
the bonded portion is a welded portion provided at a lateral portion between the first surface and the second surface of the hollow member.

5. The vehicle framework component according to claim 4, wherein
the welded portion is located near the second surface with respect to the first surface.

6. (canceled)

7. The vehicle framework component according to claim 1, wherein
a second cover that blocks an end of the reinforcing member near the second surface is bonded to the reinforcing member.

8. The vehicle framework component according to claim 1, wherein
the quasi-circular cross section of the reinforcing member has a ratio of a major axis to a minor axis of 2.5 or less.

9. The vehicle framework component according to claim 1, wherein
the at least one reinforcing member comprises a plurality of reinforcing members disposed in the hollow member, and
a distance between axes of the cylindrical tubes of the respective reinforcing members is at most four times as large as a diameter of the reinforcing members.

10. (canceled)

11. (canceled)

12. A vehicle comprising the vehicle framework component according to claim 1, the vehicle framework component being installed so that the first surface of the hollow member is situated near an inside of the vehicle and the second surface of the hollow member is situated near an outside of the vehicle.

13. A vehicle framework component comprising:
a hollow member; and
at least one reinforcing member, wherein
the hollow member comprises therein mutually facing first and second surfaces,
the reinforcing member comprises a cylindrical tube having a quasi-circular cross section,
the reinforcing member stands on the first surface or the second surface in the hollow member, and
the hollow member is made of a steel material.
